(19) United States
(12) Patent Application Publication
(10) Pub. No.: US 2018/0106300 A1
(43) Pub. Date: Apr. 19, 2018

(54) Ramp Angle Indexing Assembly for Snowmobile Clutch

(71) Applicant: Joseph Remmie Imhoff, Thunder Bay (CA)

(72) Inventor: Joseph Remmie Imhoff, Thunder Bay (CA)

(21) Appl. No.: 15/292,859

(22) Filed: Oct. 13, 2016

(51) Int. Cl. F16D 13/75; F16B 35/06

(52) U.S. Cl. CPC F16D 13/75; F16B 35/06

(57) ABSTRACT

An indexing assembly for a snowmobile drive clutch assembly includes an adapter collar having a first portion which is hexagonal in cross section for mounting in the index socket of the drive clutch housing which normally receives a conventional indexing bolt therein. The adapter collar defines a first indexing surface which mates with a corresponding second indexing surface of the indexing head of an auxiliary bolt which replaces the conventional indexing bolt to define an eccentric cam surface which defines the ramp angle of a flyweight ramp member of the drive clutch that can be adjusted through a greater number of mating positions than the conventional indexing bolt. A difference in ramp angle between sequential mating positions of the auxiliary bolt can thus be made smaller than the difference in ramp angle between sequential mating positions of the conventional indexing bolt.

### FIELD OF THE INVENTION

The present invention relates to an indexing assembly for use with a snowmobile drive clutch assembly for adjusting the ramp angle of the flyweight ramp member. More particularly, the present invention relates to a replacement indexing assembly for a drive clutch assembly including a drive clutch housing, a flyweight ramp member pivotally supported within the drive clutch housing, and an index socket formed in the drive clutch housing for receiving a bolt head of a conventional indexing bolt therein at a selected one of a plurality of different mating positions supporting the flyweight ramp member at different ramp angles respectively, in which the replacement indexing assembly replaces the conventional indexing bolt to provide a greater number of different mating positions and thus a greater number of selectable ramp angles than is normally prescribed by the index socket.

### BACKGROUND

In a TRA-type snowmobile drive clutch, manufactured by Bombardier Recreational Products, an adjustment is provided which allows fine tuning of the ramp profile. When in use, the drive clutch flyweight engages multiple angular ramps inside the drive clutch body. The angle of these ramps with respect to the flyweights determines the shift out RPM of the clutch. By changing the angle of these ramps, the peak shift RPM can be changed to optimize performance. The adjusters are eccentric cams which allow an operator to raise or lower the outer end of the ramp member within the drive clutch housing through six different positions. More particularly, the eccentric surface of the cam has a varying surface in relation to degrees of rotation to engage a spur on the backside of the ramps, and through rotational adjustment of the bolts alters the distance in which the ramp is held away from the rotational axis of the cam, ultimately changing shift out RPM as is well understood in the art. The camshaft is provided on a conventional index bolt having a hexagonal head which fits into a hexagonally shaped index socket cast into the drive clutch housing. Rotating the index bolt to a different position to cause the ramp to move toward the lever arm and make the ramp angle steeper, raises engine speed and slows the upshift. As the ramp is adjusted away from the lever arm, the engine speed is lowered and the upshift is faster. Raising the adjuster positions will typically result in a 150 to 200 RPM increase with each position change. Lowering the adjuster positions will typically result in a decrease of 150 to 200 RPM with each position change. The incremental increase and decrease between different positions is limited by the number of positions available to cover a broad range of RPM as defined by the hexagonal shape of the index socket.

### SUMMARY OF THE INVENTION

According to one aspect of the invention there is provided an indexing assembly for use with a snowmobile drive clutch assembly including a drive clutch housing, a flyweight ramp member pivotally supported within the drive clutch housing, and an index socket formed in the drive clutch housing for receiving a bolt head of an indexing bolt therein at a selected one of a plurality of different mating positions supporting the flyweight ramp member at different ramp angles respectively, the indexing bolt assembly comprising:

an adapter collar having a first portion adapted to be received non-rotatably within the index socket of the drive clutch housing and a second portion defining a first indexing surface thereon;

an auxiliary bolt for being received within the adapter collar, the auxiliary bolt comprising:
an indexing head having a second indexing surface formed thereon which mates with the first indexing surface of the adapter collar in a plurality of different mating positions;
a shaft extending longitudinally between a first end coupled to the indexing head and an opposing second end for extending through the drive clutch housing;
an eccentric cam surface supported on the shaft so as to be adapted to be engaged by the flyweight ramp member, the eccentric cam surface defining a plurality of auxiliary ramp angles corresponding to the different mating positions of the indexing head relative to the adapter collar respectively; and
a retainer for coupling to the second end of the shaft for selectively clamping the second indexing surface of the indexing head against the first indexing surface of the adapter collar at any one of the plurality of different mating positions.

According to a second aspect of the present invention there is provided a snowmobile drive clutch assembly comprising:

a drive clutch housing;

a flyweight ramp member pivotally supported within the drive clutch housing;

an index socket formed in the drive clutch housing;

an indexing bolt assembly comprising:
an adapter collar having a first portion received non-rotatably within the index socket of the drive clutch housing and a second portion defining a first indexing surface thereon;
an auxiliary bolt received within the adapter collar, the auxiliary bolt comprising:
   an indexing head having a second indexing surface formed thereon which mates with the first indexing surface of the adapter collar in a plurality of different mating positions;
   a shaft extending longitudinally between a first end coupled to the indexing head and an opposing second end so as to extend through the drive clutch housing;
   an eccentric cam surface supported on the shaft so as to be adapted to be engaged by the flyweight ramp member, the eccentric cam surface defining a plurality of auxiliary ramp angles corresponding to the different mating positions of the indexing head relative to the adapter collar respectively; and
a retainer for coupling to the second end of the shaft for selectively clamping the second indexing surface of the indexing head against the first indexing surface of the adapter collar at any one of the plurality of different mating positions.

Use of the adapter collar enables the limitations of only six different mating positions of the hexagonal shaped index socket to be overcome. The adapter collar defines a new interface for defining the different mating positions between the first index surface of the adapter collar and the second index surface of the auxiliary bolt which replaces the conventional index bolt. By using the replacement indexing assembly described herein, raising the adjuster positions will typically result in a 75 to 100 RPM increase with each position change. Similarly, lowering the adjuster positions will typically result in a decrease of 75 to 100 RPM with each position change.

Preferably the first and second indexing surfaces define a number of different mating positions that is greater than a number of different mating positions defined by the index socket and an indexing bolt received therein. In the illustrated embodiment, the first and second indexing surfaces define twice as many different mating positions as the index socket and the conventional indexing bolt received therein.

Preferably the first portion of the adapter collar is hexagonal in cross section.

Preferably the second portion of the adapter collar is increased in radial dimension relative to the first portion of the adapter collar so as to define annular shoulder which faces inwardly towards the second end of the shaft for abutment with an exterior surface of the drive clutch housing.

The first indexing surface may comprise a plurality of protruding portions at circumferentially spaced apart positions on the adapter collar and a recessed portion between each adjacent pair of the protruding portions which is recessed in an axial direction inwardly relative to protruding portions. Preferably a height of the protruding portions relative to the recessed portions of the first indexing in the axial direction is less than a length in the axial direction of the first portion of the adapter collar that mates with the index socket. When the retainer comprises a threaded nut, preferably a height of the protruding portions relative to the recessed portions of the first indexing in the axial direction is less than a length in the axial direction of a threaded connection between the threaded nut and the shaft.

The assembly may further comprise an indexing mark formed on one of the indexing head or the adapter collar and a plurality of indicia formed on the other one of the indexing head or the adapter collar which are arranged for selective alignment with the indexing mark so as to correspond to the different mating positions of the auxiliary bolt relative to the adapter collar.

Preferably a difference in ramp angle between sequential ones of the different mating positions of the auxiliary bolt relative to the adapter collar is approximately half of a difference in ramp angle between sequential ones of the different mating positions of the indexing bolt relative to the index socket.

### BRIEF DESCRIPTION OF THE DRAWINGS

One embodiment of the invention will now be described in conjunction with the accompanying drawings in which:

FIG. 1 is a perspective view of a snowmobile drive clutch housing receiving a conventional index bolt therein;

FIG. 2 is a schematic representation of the ramp member engaged upon the eccentric cam surface of the conventional index bolt within the snowmobile drive clutch housing;

FIG. 3 is a perspective view of the indexing assembly according to the present invention for use in place of the conventional index bolt within the snowmobile drive clutch housing according to FIG. 1;

FIG. 4 is an exploded view of the indexing assembly;

FIG. 5 is a sectional view of the indexing assembly in a mounted position within the snowmobile drive clutch housing according to FIG. 1;

FIG. 6 is a partly sectional perspective view of the indexing assembly in a released position;

FIG. 7 is a perspective view of the auxiliary bolt of the indexing assembly;

FIG. 8 is a perspective view of the second end of the auxiliary bolt received through the adapter collar of the indexing assembly;

FIG. 9 is an inner end view of the adapter collar of the indexing assembly;

FIG. 10 is a side view of the adapter collar;

FIG. 11 is an inner end view of the index head of the auxiliary bolt of the indexing assembly; and

FIG. 12 is a side view of the auxiliary bolt.

In the drawings like characters of reference indicate corresponding parts in the different figures.

### DETAILED DESCRIPTION

Referring to the accompanying figures there is illustrated an indexing assembly generally indicated by reference numeral 10. The indexing assembly 10 is particularly suited for use with a snowmobile drive clutch assembly 12.

The snowmobile drive clutch assembly 12 typically includes a housing 14 locating clutch components therein including a clutch flyweight. A ramp member 16 which is engaged by the clutch flyweight is also supported within the housing 14. The ramp member 16 is pivotally supported at one end for pivotal movement about a respective pivot axis to vary the ramp angle of a ramp surface 18 which is engaged by the clutch flyweight.

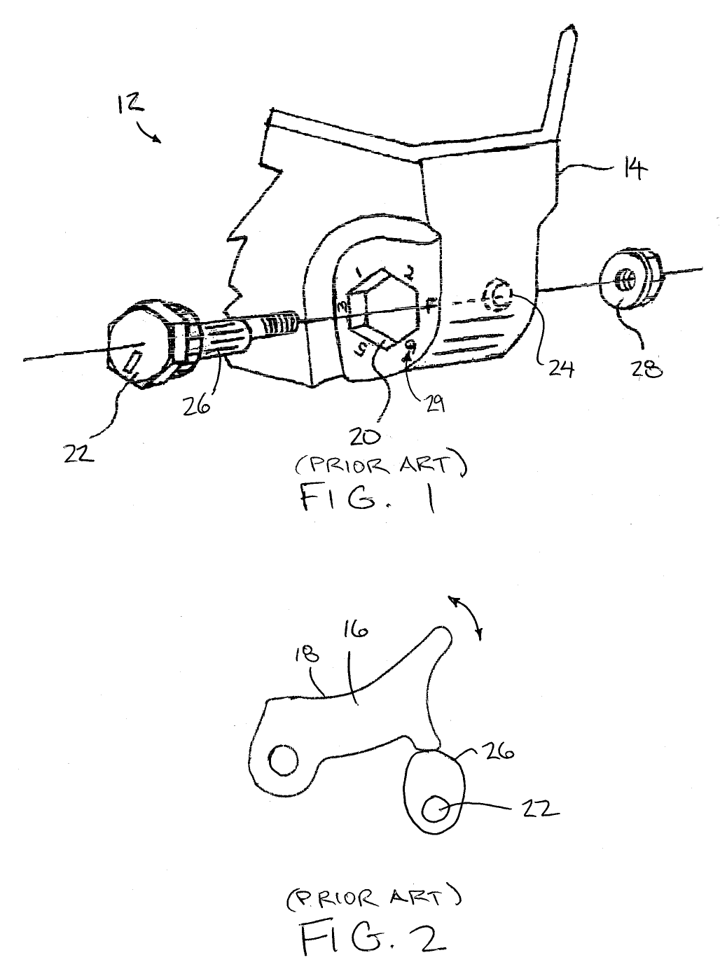

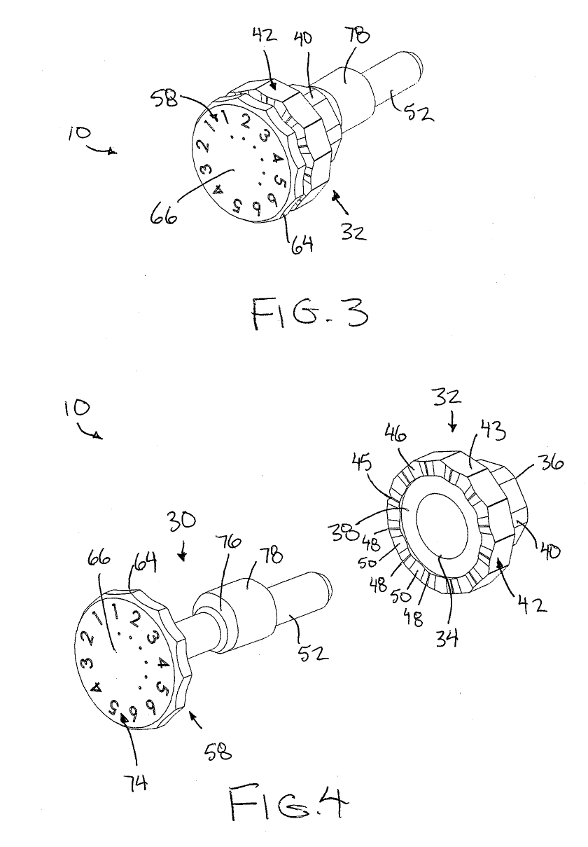

The drive clutch housing 14 further includes an index socket 20 formed into a portion of the exterior wall of the housing to normally receive a conventional index bolt 22 as shown in FIG. 1. A bolt aperture 24 is also provided in a portion of the exterior wall of the housing opposite from the index socket 20 to receive the shaft of the index bolt extending fully through a corresponding portion of the drive clutch housing between the index socket 20 and the bolt aperture 24. An eccentric cam surface 26 is provided on the shaft of the conventional index bolt 22 which is normally engaged by the ramp member 16 to determine the ramp angle of the ramp surface 18. A nut 28 is provided externally of the housing which is threaded onto the second end of the index bolt 22 opposite a bolt head of the index bolt. The bolt head of the conventional index bolt 22 has a hexagonal shape for mating alignment within the index socket 20 in any one of six different mating positions. Each different position corresponds to a 60° rotation about the axis of the index bolt relative to a previous one of the positions. The profile of the cam surface 26 of the conventional index bolt 22 varies in radius at the point of contact with the ramp member by a suitable amount such that each change in position through a sequence of the different positions of the conventional index bolt results in a raising of the engine speed at which shifting occurs by approximately 150 to 200 RPM.

The index assembly 10 according to the present invention replaces the conventional index bolt with the auxiliary bolt 30 which is mated to the index socket 20 of the drive clutch housing using an adapter collar 32.

The adapter collar 32 includes a central bore 34 extending axially fully through the collar from a first end 36 to an opposing second end 38 thereof. The body of the adapter collar includes a first portion 40 at the first end 36 thereof and a second portion 42 at the second end 38 thereof such that the first and second portions are axially in series and fully surround the central bore 34. The first portion 40 has an outer surface having a hexagonal cross section which is suitably sized and shaped to mate closely with the dimensions of the index socket 20 of the drive clutch housing.

The second portion 42 is increased in a radial dimension relative to the first portion so as to define an annular flange protruding radially outward from the first portion about the full circumference thereof for engagement against the outer surface of the drive clutch housing surrounding the index socket 20 respectively. The outer perimeter edge 43 of the second portion 42 of the collar has a polygonal cross-section with twice as many sides as the head of the conventional index bolt, that is the outer perimeter edge has 12 sides. A notch 45 is recessed radially inwardly at a central location in one of the sides of the perimeter edge for use as position indicator as described in further detail below.

The second portion joins the first portion so as to be generally stepped in profile to define an inner shoulder 44 in the form of an annular inner end face lying perpendicular to the axis of the collar. The inner shoulder has a radial dimension of sufficient size to span over any indicia 29 provided on the exterior surface of the housing which otherwise indicates the six positions of the conventional index bolt.

The outer end face 46 of the second portion of the collar lies generally within a plane which is perpendicular to the axis but is shaped to define a first index surface of the indexing assembly 10. The first index surface has a generally sinusoidal profile in the circumferential direction in the form of a plurality of protrusions 48 in the axial direction and a plurality of recesses 50 which are recessed axially inwardly in relation to the protrusions. More particularly one of the protrusions 48 is aligned centrally with each of the twelve flat sides of the polygonal perimeter edge, and one of the recesses 50 is located circumferentially between each adjacent pair of the protrusions 48.

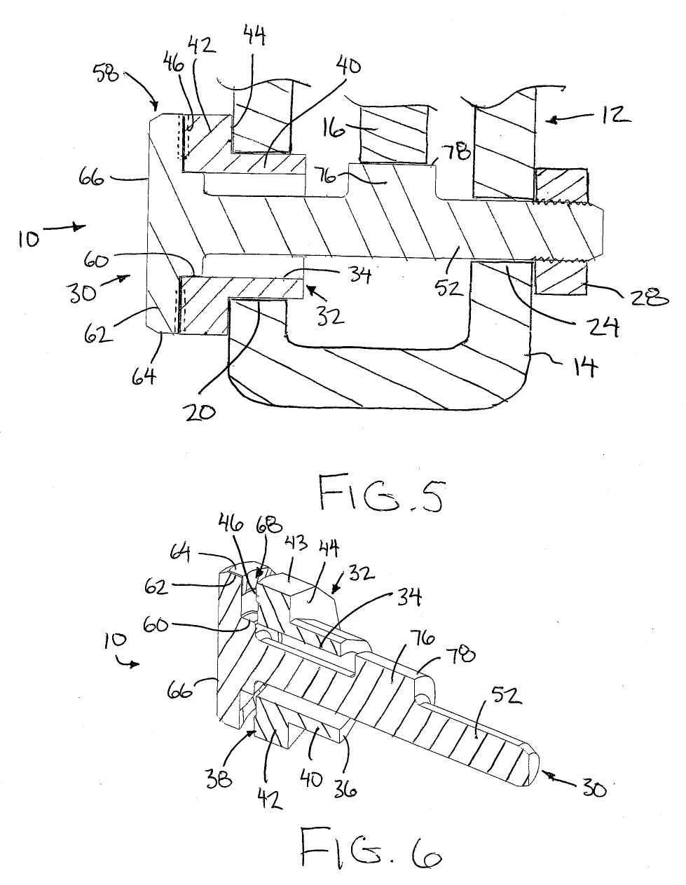

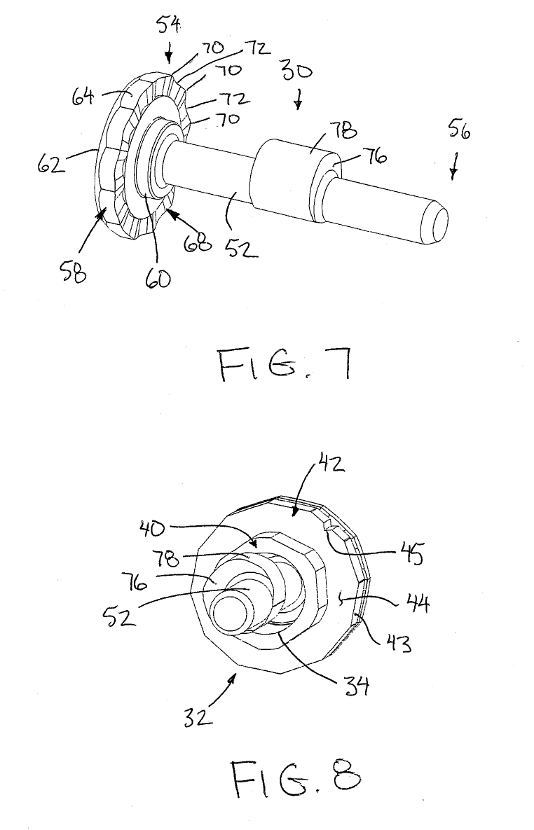

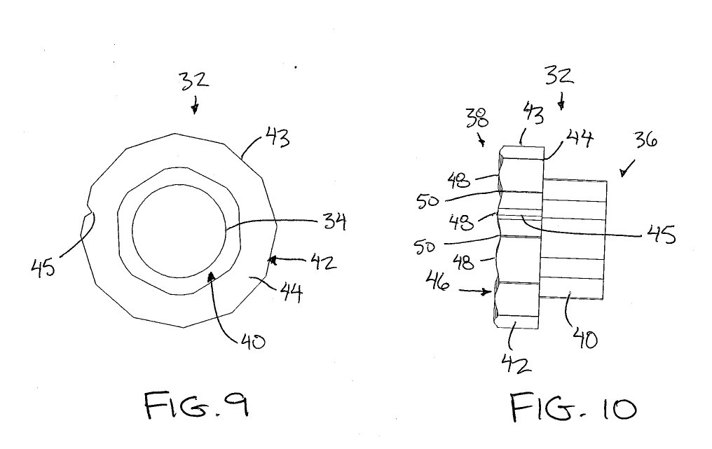

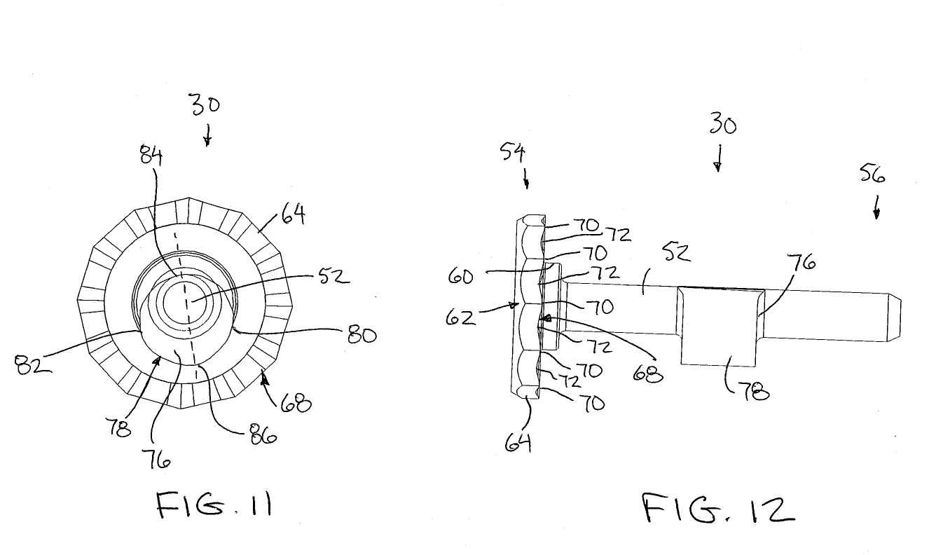

The auxiliary bolt 30 comprises an elongate shaft 52 extending axially from a first end 54 to an opposing second end 56. The length of the shaft enables the shaft to be received fully through the corresponding portion of the drive clutch housing between the index socket 20 and the opposing bolt aperture 24. The second end of the shaft is threaded for receiving the nut 28 threaded thereon which acts as a retainer member for clamping engagement with the corresponding outer surface of the housing surrounding the bolt aperture 24 in a mounted position as shown in FIG. 5.

An index head 58 is supported on the first end of the shaft which is stepped in outer diameter so as to include an inner portion 60 directly adjacent the first end of the shaft, and an outer portion 62 which is located axially outward relative to the inner portion. The inner portion 60 is generally cylindrical in shape having an outer diameter which is aligned concentrically with the shaft but which is enlarged in diameter relative to the shaft such that the outer diameter fits closely within the inner diameter of the bore 34 extending through the adapter collar 32.

The length of the inner portion 60 in the axial direction is more than twice the overall height in the axial direction of the protrusions 48 relative to the recesses 50 of the first index surface. In this manner, the index head 58 can be disengaged from the first index surface 46 while the inner portion 60 of the index head 58 remains concentrically aligned with and at least partially received within the central bore 34 of the adapter collar.

The outer portion 62 of the index head 58 is increased in diameter relative to the inner portion so as to have a generally flat cylindrical shape. The perimeter edge 64 of the outer portion 62 is generally polygonal in shape having 12 sides, so as to correspond in shape and dimension to the 12 sides of the second portion 42 of the adapter collar 32. The outer end face 66 of the outer portion 62 is generally flat and circular so as to lie substantially perpendicularly to the axis of the auxiliary bolt 30. The stepped diameter between the inner portion 60 and the outer portion 62 of the index head defines an inner shoulder in the form of an annular inner end face 68 which lies generally perpendicular to the axis but which is shaped in profile to define a second index surface.

The second index surface similarly includes a plurality of protrusions 70 which protrude in the axial direction relative to a plurality of recesses 72 which are recessed inwardly into the body of the outer portion 62 relative to the protrusions. Each protrusion 70 of the second index surface is aligned with and matches the profile of a corresponding recess of the first index surface. Likewise, each recess 72 of the second index surface matches the profile of and receives the corresponding protrusion of the first index surface therein in a mated position.

The first and second index surfaces are thus arranged to mate with one another in 12 different positions. Each position corresponds to a rotation of the auxiliary bolt 30 relative to the adapter collar 32 of approximately 30° relative to the previous position. An overall height in the axial direction of either set of protrusions relative to the respective recesses thereof is arranged to be less than the axial length of the portion of the shaft in threaded engagement with the nut. In this manner the nut only requires partial loosening while still remaining threadably engaged upon the shaft to allow sufficient axial displacement of the auxiliary bolt 30 relative to the adapter collar 32 to provide sufficient clearance between the first and second index surfaces to allow for rotation of the auxiliary bolt 30 between the 12 different positions thereof.

Suitable indicia 34 is provided on the outer end face 66 in alignment with each of the sides of the perimeter edge of the outer portion 62 of the index bolt for selective alignment with the notch 45 in the adapter collar to indicate a selected one of the positions.

A lobe 76 is provided at an intermediate location along the shaft of the auxiliary bolt which defines an eccentric cam surface 78 extending about the exterior circumference thereof in which the radius of the cam surface relative to the central axis of the auxiliary bolt varies about the circumference of the bolt. In each of the mated positions of the first index surface relative to the second index surface, a different portion of the cam surface 78 of the lobe is aligned with the ramp member engaged thereon corresponding to a respective prescribed ramp angle of the ramp member.

The lobe 76 includes a first side 80 and a diametrically opposed second side 82 which each extend circumferentially from a first end 84 of the lobe where the radius is smallest to an opposing second end 86 of the lobe where the diameter is largest. A first set of six sides of the index head of the auxiliary bolt in sequence with one another include indicia 1 through 6 associated therewith. When each of the sides of the first set are aligned with the notch 45, corresponding portions of the first side 80 of the lobe are aligned with the point of engagement with the ramp member respectively. The radius of each of the corresponding point of engagement along the first side which correspond with the positions associated with indicia 1 through 6 correspond to respective ones of all six positions of the conventional index bolt 22.

A second set of six sides of the index head of the auxiliary bolt in sequence with one another include indicia 1′ through 6′. When each of the sides of the second set are aligned with the notch 45, corresponding portions of the second side 82 of the lobe are aligned with the point of engagement with the ramp member respectively. The radius of each corresponding point of engagement along the second side which correspond with the positions associated with indicia 1′ through 5′ has a magnitude which is halfway between the radiuses of two corresponding positions from the first side. That is, the radius at position 1′ is halfway between the radius at position 1 and the radius at position 2. Likewise, the radius at position 2′ is halfway between the radius at position 2 and the radius at position 3. The increase in a radial dimension of each of positions 1′ through 6′ is increased relative to the corresponding positions 1 through 6 by the same incremental amount such that the radius at the point of engagement corresponding to position 6′ is incrementally larger than the radius at position 6.

The profile of the cam surface of the auxiliary bolt 30 thus varies in radius at the point of contact with the ramp member by a suitable amount such that each change in position through a sequence of the different positions of the auxiliary bolt 30 (1, 1′, 2, 2′, 3, 3′, 4, 4′, 5, 5′, 6, and 6′) results in a raising of the engine speed at which shifting occurs by approximately 75 to 100 RPM. The smaller increments in RPM are achieved while maintaining the same overall range through which RPM can be adjusted by use of the adapter collar which varies the limitation of six positions defined by the hexagonal index socket 20 to any number of desired positions according to the profile of the first and second index surfaces.

In further embodiments, the shape and configuration of the index surfaces may be varied to result in a different number of auxiliary positions provided which in turn varies the increment in RPM change between different positions as well as possibly varying the overall range of RPM change permitted as may be desired.

In further embodiments, the auxiliary bolt may be retained by various means other than use of a conventional threaded not 28, for example by use of retainer pins, clips, or a quick releasing assembly which may incorporate spring tension to selectively release the auxiliary bolt from a selected position.

Since various modifications can be made in my invention as herein above described, and many apparently widely different embodiments of same made, it is intended that all matter contained in the accompanying specification shall be interpreted as illustrative only and not in a limiting sense.

1. An indexing assembly for use with a snowmobile drive clutch assembly including a drive clutch housing, a flyweight ramp member pivotally supported within the drive clutch housing, and an index socket formed in the drive clutch housing for receiving a bolt head of an indexing bolt therein at a selected one of a plurality of different mating positions supporting the flyweight ramp member at different ramp angles respectively, the indexing bolt assembly comprising:
an adapter collar having a first portion adapted to be received non-rotatably within the index socket of the drive clutch housing and a second portion defining a first indexing surface thereon;
an auxiliary bolt for being received within the adapter collar, the auxiliary bolt comprising:
an indexing head having a second indexing surface formed thereon which mates with the first indexing surface of the adapter collar in a plurality of different mating positions;
a shaft extending longitudinally between a first end coupled to the indexing head and an opposing second end for extending through the drive clutch housing;
an eccentric cam surface supported on the shaft so as to be adapted to be engaged by the flyweight ramp member, the eccentric cam surface defining a plurality of auxiliary ramp angles corresponding to the different mating positions of the indexing head relative to the adapter collar respectively; and
a retainer for coupling to the second end of the shaft for selectively clamping the second indexing surface of the indexing head against the first indexing surface of the adapter collar at any one of the plurality of different mating positions.

2. The assembly according to claim 1 wherein the first and second indexing surfaces define a number of different mating positions that is greater than a number of different mating positions defined by the index socket and an indexing bolt received therein.

3. The assembly according to claim 2 wherein the first and second indexing surfaces define twice as many different mating positions as the index socket and an indexing bolt received therein.

4. The assembly according to claim 1 wherein the first portion of the adapter collar is hexagonal in cross section.

5. The assembly according to claim 1 wherein the second portion of the adapter collar is increased in radial dimension relative to the first portion of the adapter collar so as to define annular shoulder which faces inwardly towards the second end of the shaft for abutment with an exterior surface of the drive clutch housing.

6. The assembly according to claim 1 wherein the first indexing surface comprises a plurality of protruding portions at circumferentially spaced apart positions on the adapter collar and a recessed portion between each adjacent pair of the protruding portions which is recessed in an axial direction inwardly relative to protruding portions.

7. The assembly according to claim 6 wherein a height of the protruding portions relative to the recessed portions of the first indexing in the axial direction is less than a length in the axial direction of the first portion of the adapter collar that mates with the index socket.

8. The assembly according to claim 6 wherein the retainer comprises a threaded nut, and wherein a height of the protruding portions relative to the recessed portions of the first indexing in the axial direction is less than a length in the axial direction of a threaded connection between the threaded nut and the shaft.

9. The assembly according to claim 1 further comprising an indexing mark formed on one of the indexing head or the adapter collar and a plurality of indicia formed on the other one of the indexing head or the adapter collar which are arranged for selective alignment with the indexing mark so as to correspond to the different mating positions of the auxiliary bolt relative to the adapter collar.

10. The assembly according to claim 1 wherein a difference in ramp angle between sequential ones of the different mating positions of the auxiliary bolt relative to the adapter collar is approximately half of a difference in ramp angle between sequential ones of the different mating positions of the indexing bolt relative to the index socket.

11. A snowmobile drive clutch assembly comprising:
a drive clutch housing;
a flyweight ramp member pivotally supported within the drive clutch housing;
an index socket formed in the drive clutch housing;
an indexing bolt assembly comprising:
an adapter collar having a first portion received non-rotatably within the index socket of the drive clutch housing and a second portion defining a first indexing surface thereon;
an auxiliary bolt received within the adapter collar, the auxiliary bolt comprising:
an indexing head having a second indexing surface formed thereon which mates with the first indexing surface of the adapter collar in a plurality of different mating positions;
a shaft extending longitudinally between a first end coupled to the indexing head and an opposing second end so as to extend through the drive clutch housing;
an eccentric cam surface supported on the shaft so as to be adapted to be engaged by the flyweight ramp member, the eccentric cam surface defining a plurality of auxiliary ramp angles corresponding to the different mating positions of the indexing head relative to the adapter collar respectively; and
a retainer for coupling to the second end of the shaft for selectively clamping the second indexing surface of the indexing head against the first indexing surface of the adapter collar at any one of the plurality of different mating positions.
